(19) United States
(12) Patent Application Publication
(10) Pub. No.: US 2026/0238309 A1
(43) Pub. Date: Aug. 13, 2026

(54) SIDELINK BEAM MANAGEMENT

(71) Applicant: TOYOTA JIDOSHA KABUSHIKI KAISHA, Toyota-shi, Aichi-ken (JP)

(72) Inventors: Thomas Haaning JACOBSEN, Noerresundby (DK); Nuno Manuel KIILERICH PRATAS, Gistrup (DK); Renato BARBOSA ABREU, Aalborg (DK); Takayuki SHIMIZU, Mountain View, CA (US); Claude ARZELIER, Varna (BG); Torsten WILDSCHEK, Gloucester (GB); Daniel MEDINA, Munchen (DE)

(73) Assignee: TOYOTA JIDOSHA KABUSHIKI KAISHA, Toyota-shi, Aichi-ken (JP)

(21) Appl. No.: 19/156,774

(22) PCT Filed: Dec. 28, 2023
(86) PCT No.: PCT/JP2023/047192

§ 371 Date: Aug. 14, 2025

Related U.S. Application Data
(60) Provisional application No. 63/445,884, filed on Feb. 15, 2023.

(51) Int. Cl. H04B 7/06

(52) U.S. Cl. CPC H04B 7/06954

(57) ABSTRACT

Disclosed are methods, apparatuses, and systems for beam management for a user equipment (UE) in a sidelink communication. The method includes: establishing, by a first UE, a beam alignment with a second UE using a first beam; receiving a second-beam assistance indication, the second-beam assistance indication indicating at least one of time information or frequency information associated with a second beam for the second UE; transmitting a second-beam configuration; receiving a confirmation of the second-beam configuration; determining whether a selection of a resource is triggered, the selection of resource being associated with use of the second beam; in response to a determination that the selection of the resource is triggered, updating a candidate resource set and selecting one or more resources from an updated candidate resource set; and transmitting one or more signals or messages using the one or more resources selected from the updated candidate resource set.

### CROSS-REFERENCE TO RELATED PATENT APPLICATION

This application claims the benefit of U.S. Provisional Application No. 63/445,884, filed on Feb. 15, 2023, entitled “SIDELINK BEAM MANAGEMENT,” the entirety of which is incorporated by reference herein.

### TECHNICAL FIELD

Apparatuses and methods consistent with the present disclosure relate generally to communications, more specifically, methods, systems, and devices for beam management in sidelink communications.

### BACKGROUND ART

Sidelink communication technology enables direct communication between two or more devices, for example, two or more vehicles in a vehicle-to-everything (V2X) communication. When a transmitter device in a sidelink communication transmits data to a receiver device using a narrow beam, the receiver device can use a wide reception beam or a narrow reception beam to receive the data. The wide reception beam may allow a stable reception for the receiver device, even if there are one or more other devices in the sidelink communication also transmitting data to the receiver device at the same time as the transmitter device. But continuously using a wide reception beam may not be practical, especially for high frequency radio signals that require focused narrow beams to compensate for the high path loss. On the other hand, using the narrow reception beam may provide advantages for the receiver device, especially in a high frequency sidelink communication. But the beam correspondence between the narrow reception beam and the narrow transmission beam may be lost easily.

Moreover, when there are one or more other devices transmitting data to the receiver device at the same time as the transmitter device, the narrow reception beam may not allow the receiver device to receive transmissions from the multiple devices at the same time. Systems and methods for flexible and efficient sidelink beam management are desired.

### SUMMARY OF INVENTION

According to some embodiments of the present disclosure, there is provided a user equipment (UE) for a sidelink communication. The UE includes a memory storing an instruction; and a processor configured to execute the instruction stored in the memory to: establish, using a first beam, a beam alignment with a second UE; receive, from the second UE, a second-beam assistance indication, the second-beam assistance indication indicating at least one of time information or frequency information associated with a second beam for the second UE for reception of a signal or data from the first UE; transmit, to the second UE, a second-beam configuration, in response to receiving the second-beam assistance indication; receive, from the second UE, a confirmation of the second-beam configuration; determine whether a selection of a resource is triggered, the selection of the resource being associated with use of the second beam; in response to a determination that the selection of the resource is triggered, update a candidate resource set and select one or more resources from an updated candidate resource set, such that the one or more selected resources are associated with the use of the second beam; and transmit one or more signals or messages using the one or more resources selected from the updated candidate resource set.

According to some embodiments of the present disclosure, there is provided a second UE for a sidelink communication. The second UE includes a memory storing an instruction; and a processor configured to execute the instruction stored in the memory to: establish, using a first beam, a beam alignment with a first UE; transmit, to the first UE, a second-beam assistance indication, the second-beam assistance indication indicating at least one of time information or frequency information associated with a second beam for the second UE for reception of a signal or data from the first UE; receive, from the first UE, a second-beam configuration, in response to the transmitting the second-beam assistance indication; and transmit, to the first UE, a confirmation of the second-beam configuration.

According to some embodiments of the present disclosure, there is provided a method for beam management in a sidelink communication. The method includes establishing, by a first UE in the sidelink communication, a beam alignment with a second UE using a first beam; receiving, from the second UE, a second-beam assistance indication, the second-beam assistance indication indicating at least one of time information or frequency information associated with a second beam for the second UE for reception of a signal or data from the first UE; transmitting, to the second UE, a second-beam configuration, in response to receiving the second-beam assistance indication; receiving, from the second UE, a confirmation of the second-beam configuration; determining, by the first UE, whether a selection of a resource is triggered, the selection of resource being associated with use of the second beam; in response to a determination that the selection of the resource is triggered, updating a candidate resource set and selecting one or more resources from an updated candidate resource set, such that the one or more selected resources are associated with the use of the second beam; and transmitting one or more signals or messages using the one or more resources selected from the updated candidate resource set.

According to some embodiments of the present disclosure, there is provided a method for beam management in a sidelink communication. The method includes establishing, by a second UE in the sidelink communication, a beam alignment with a first UE using a first beam; transmitting, to the first UE, a second-beam assistance indication, the second-beam assistance indication indicating at least one of time information or frequency information associated with a second beam for the second UE for reception of a signal or data from the first UE; receiving, from the first UE, a second-beam configuration, in response to the transmitting the second-beam assistance indication; and transmitting, to the first UE, a confirmation of the second-beam con-figuration.

According to some embodiments of the present disclosure, there is provided a non-transitory computer-readable medium storing instructions that are executable by one or more processors of a UE in a sidelink communication to perform a method. The method includes establishing, by the first UE, a beam alignment with a second UE for the sidelink communication using a first beam; receiving, from the second UE, a second beam assistance indication, the second-beam assistance indication indicating at least one of time information or frequency information associated with a second beam for the second UE for reception of a signal or data from the first UE; transmitting, to the second UE, a second-beam configuration, in response to receiving the second-beam assistance indication; receiving, from the second UE, a confirmation of the second-beam configuration; determining, by the first UE, whether a selection of a resource is triggered, the selection of resource being associated with use of the second beam; in response to a determination that the selection of the resource is triggered, updating a candidate resource set and selecting one or more resources from an updated candidate resource set, such that the one or more selected resources are associated with the use of the second beam; and transmitting one or more signals or messages using the one or more resources selected from the updated candidate resource set.

According to some embodiments of the present disclosure, there is provided a non-transitory computer-readable medium storing instructions that are executable by one or more processors of a second UE in a sidelink communication to perform a method.

The method includes establishing a beam alignment with a first UE for the sidelink communication using a first beam; transmitting, to the first UE, a second-beam assistance indication, the second-beam assistance indication indicating at least one of time information or frequency information associated with a second beam for the second UE for reception of a signal or data from the first UE; receiving, from the first UE, a second-beam configuration, in response to the transmitting the second-beam assistance indication; and transmitting, to the first UE, a confirmation of the second-beam configuration.

### BRIEF DESCRIPTION OF DRAWINGS

FIG. 1 is a schematic diagram illustrating a first mode for resource allocation in a sidelink communication, consistent with some embodiments of the present disclosure.

FIG. 2 is a schematic diagram illustrating a second mode for resource allocation in a sidelink communication, consistent with some embodiments of the present disclosure.

FIG. 3A is a schematic diagram illustrating a slot structure in a sidelink communication.

FIG. 3B is a schematic diagram illustrating another slot structure in a sidelink communication, consistent with some embodiments of the present disclosure.

FIG. 4 is a schematic diagram illustrating a method for beam alignment between a UE and a base station, consistent with some embodiments of the present disclosure.

FIG. 5 is a schematic diagram illustrating a method for sidelink beam alignment between two UEs in a sidelink communication, consistent with some embodiments of the present disclosure.

FIG. 6 is a schematic diagram illustrating a method for configuration alignment in a discontinuous reception (DRX), consistent with some embodiments of the present disclosure.

FIG. 7A is a schematic diagram illustrating sidelink communication between a receiver (Rx) UE using wide beams and two transmitter (Tx) UEs using narrows beams. FIG. 7B is a schematic diagram illustrating sidelink communication between an Rx UE using narrow beams and two Tx UEs using narrow beams, consistent with some embodiments of the present disclosure.

FIG. 8 is a schematic diagram illustrating a method for sidelink beam alignment between two UEs in a sidelink communication, consistent with some embodiments of the present disclosure.

FIG. 9 is a block diagram of a UE, consistent with some embodiments of the present disclosure.

### DESCRIPTION OF EMBODIMENTS

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of systems, apparatuses, and methods consistent with aspects related to the present disclosure as recited in the appended claims.

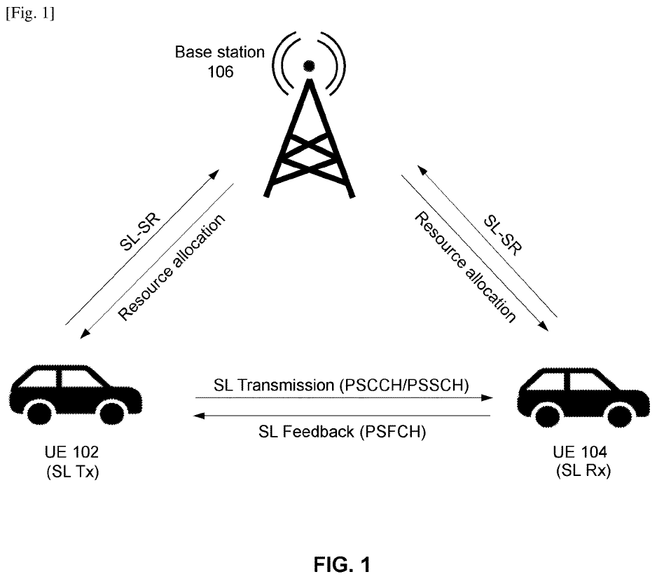

FIG. 1 is a schematic diagram illustrating a first mode for resource allocation in a sidelink communication, consistent with some embodiments of the present disclosure. Referring to FIG. 1, a communication system includes a UE 102, a UE 104, and a base station 106. The UE 102 may be a Tx UE in a sidelink communication (SL), and the UE 104 may be an Rx UE in the sidelink communication. The UE 102 and the UE 104 can be any form of UEs, for example, two vehicles in a V2X communication. The base station 106 can be any base station (e.g., gNodeB (gNB)) currently existing, such as base stations for long term evolution (LTE) or new radio (NR), or base stations for a future generation (6^{th} generation (6G), 7^{th} generation (7G), or any other future generation) radio access technology (RAT). The UE 102 and the UE 104 may communicate each other using sidelink signals. For example, the UE 102 may transmit a physical sidelink control channel (PSCCH) and/or physical sidelink shared channel (PSSCH) to the UE 104, and in response, the UE 104 may transmit a feedback signal, such as physical sidelink feedback channel (PSFCH) to the UE 102. The UE 102 and the UE 104 may also communicate with one or more other UEs in the sidelink communication.

In a first mode for resource allocation, when the UE 102 has data and/or signals to transmit, the UE 102 may request resources from the base station 106. For example, the UE 102 may transmit a signal, such as a sidelink-scheduling request (SL-SR) signal to the base station 106. In some embodiments, the UE 102 may transmit the SL-SR via sidelink-buffer status report (SL-BSR) signal. The SL-BSR may be a medium access control (MAC) control element (CE) from the UE 102 to the base station 106 and may carry information on the amount of data in the buffer of the UE 102 to be sent out. In some embodiments, the UE 102 may transmit the SL-SR via physical uplink control channel (PUCCH) configured for a sidelink logical channel.

Upon receipt of the signal from the UE 102, the base station 106 may determine the resources to be allocated to the UE 102 and transmit a signal indicating the resource allocation to the UE 102. For example, the base station 106 may use dynamic sidelink grant downlink control information (DCI) to grant sidelink resources for up to three transmissions of a transport block. The base station 106 may also provide one or multiple configured grants allocating periodic sidelink resources to the UE 102. Similar to the UE 102, the UE 104 may also transmit an SL-SR to the base station 106, and the base station 106 may also perform resource allocation for the UE 104 and transmit a signal indicating the resource allocation for the UE 104.

In some embodiments, the base station 106 may configure a single resource pool spanning the whole spectrum including unavailable part(s) for the UE 102 and/or the UE 104. In some embodiments, the base station 106 may configure only one or more sub-channels containing one or more available physical resource blocks (PRBs) for the

### Ue 102 And/or Ue 104.

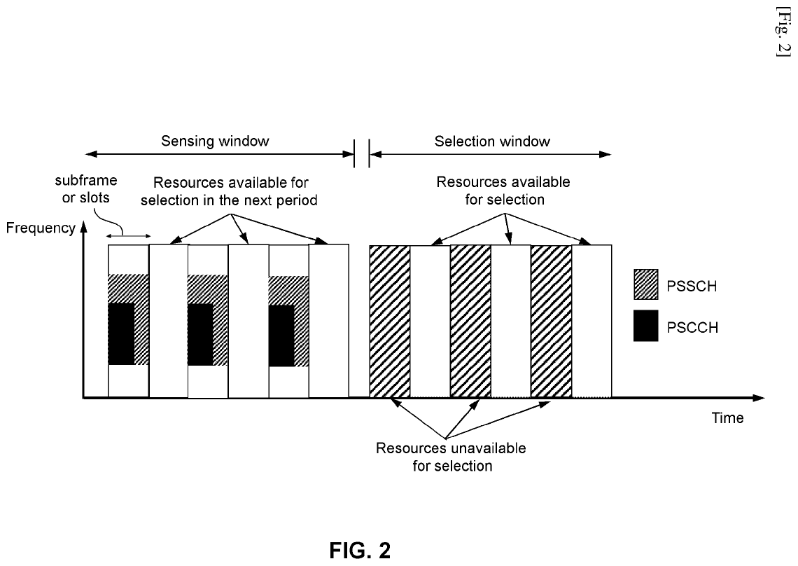

FIG. 2 is a schematic diagram illustrating a second mode for resource allocation in a sidelink communication, consistent with some embodiments of the present disclosure.
In the second mode for the resource allocation, the UE 102 (and similarly the UE 104) may autonomously perform resource selection with the aid of a sensing procedure. For example, the UE 102 may perform a channel sensing over the configured sidelink transmission resource pool(s), in order to obtain information about the resources reserved by other UE(s). The channel sensing may be a background sensing and/or any other type of full sensing or partial sensing. Referring to FIG. 2, the UE 102 may perform a channel sensing in a sensing window and collect resource reservation information of other UE(s). For example, the UE 102 may collect resource reservation information of other UE(s) based on decoding of sidelink control information (SCI) included in a sidelink signal received from the other UE(s). The UE 102 may decode the SCI based on two stages: a first stage SCI (SCI format 1-A) and a second stage SCI (SCI format 2-A or 2-B) as defined in the 3^{rd} Generation Partnership Project (3GPP) specifications. Based on the channel sensing, the UE 102 may determine candidate resources, for example, by excluding occupied, reserved, and/or unmonitored resources. As shown in FIG. 2, the radio resources can be divided into the resources in the time domain and the resources in the frequency domain. The candidate resources in the time domain may be, for example, one or more frames, subframes, slots, or symbols available for selection for the next period. In the frequency domain, the candidate resources may be, for example, one or more channels or sub-channels. FIG. 2 shows, for example, three available subframes or slots in the time domain among a plurality of subframes or slots. Each subframe or slot may include one or more symbols for PSCCH, and one or more symbols for PSSCH. Once a resource selection (or reselection) is triggered, during a selection window, the UE 102 may select resource(s) from the available sidelink resources based on the channel sensing information.

In some embodiments, the UE 102 may be configured with one of the two modes (the first mode and the second mode) for resource allocation. In some embodiments, the UE 102 may be configured with both modes for resource allocation. In some embodiments, the UE 102 may switch back and forth between the first mode and the second mode for resource allocation.

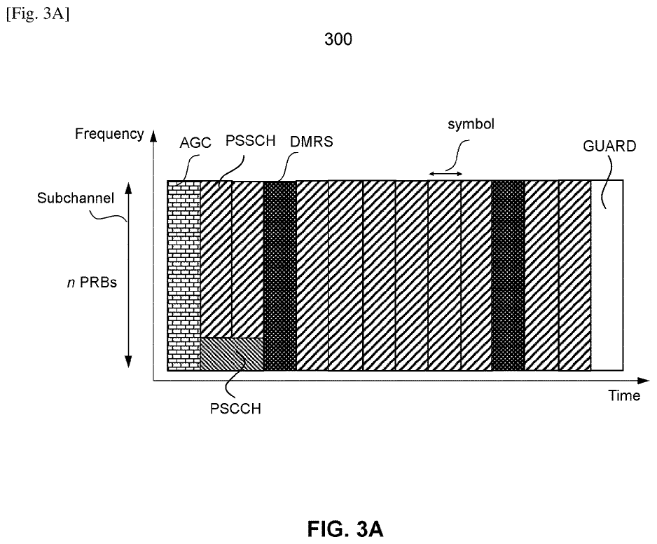

FIG. 3A is a schematic diagram illustrating a slot structure 300 in a sidelink communication, consistent with some embodiments of the present disclosure. The slot 300 can be used for the first mode or the second mode of resource allocation described above. Referring to FIG. 3A, in the time domain, the slot 300 includes 14 orthogonal frequency division multiplexing (OFDM) symbols. Among the 14 OFDM symbols, two symbols are used for demodulation reference signal (DMRS), one symbol (the first symbol) is used for automatic gain control (AGC), one symbol (the last symbol) is used for a guard period, and the rest of the symbols are used for the PSCCH or PSSCH. In the frequency domain, the slot 300 may include one or more subchannels, each consisting of one or more physical resource blocks (PRBs).

In some embodiments, the slot 300 is used in legacy sidelink communication based on contiguous resource blocks. In this case, in the frequency domain, a resource pool may consist of a set of consecutive subchannels, where one subchannel consists of a number of consecutive resource blocks. The total number of resource blocks within a given resource pool can be configured with a value ranging from 10 to 275. Generally, sidelink resource allocation, sensing, and resource selection operations are based on subchannel. The size of subchannel is configurable and can take the values 10, 12, 15, 20, 25, 50, 75, and 100 PRBs, and there can be from 1 to 27 configured number of sub-channels in a given resource pool. Referring to FIG. 3A, the PSCCH transmission is associated with the lowest subchannel of the scheduled PSSCH, indicating that the bandwidth size (in terms of number of PRBs) of PSCCH is always smaller or equal to the size of one subchannel. The configuration of the PSCCH is also part of the resource pool configuration and can be done, for example, by radio resource control (RRC) signaling. As an example, the PSCCH may be configured or pre-configured such that in the frequency domain, it can occupy a number (e.g., 10, 12, 15, 20, or 25, ≤subchannel size) of PRBs and in the time domain, it can occupy a number (e.g., 2 or 3) of OFDM symbols which are configured by a resource pool signaling (e.g., RRC signaling) or pre-configured. The number of resources for PSCCH in the frequency domain can be indicated as sl-FreqResourcePSCCH, and the number of resources for PSCCH in the time domain can be indicated as sl-TimeResourcePSCCH.

FIG. 3B is a schematic diagram illustrating another slot structure 310 in a sidelink communication, consistent with some embodiments of the present disclosure. The slot 310 can be used for the first mode or the second mode of resource allocation described above. Referring to FIG. 3B, in the time domain, the slot 310 includes 14 OFDM symbols, in which one of the symbols is used for PSFCH, two of the symbols are used for DMRS, two of the symbols are used for the guard period, one of the symbols is used for AGC, and the rest of the symbols are used for the PSCCH or PSSCH. In the frequency domain, the slot 310 may include one or more subchannels, each consisting of one or more physical resource blocks (PRBs). Similar to the slot 300, as shown in FIG. 3B, the PSCCH transmission is associated with the lowest subchannel of the scheduled PSSCH. The configuration of the PSCCH (e.g., DMRS, modulation and coding scheme (MCS), number of symbols used) is part of the resource pool con-figuration. Furthermore, the indication of which slot(s) have PSFCH symbols is also part of the resource pool configuration. However, the configuration of the PSSCH (e.g., the number of symbols used, the DMRS pattern and the MCS) is provided by the first stage SCI which is the payload sent within the PSCCH and follows the con-figuration depicted in 3GPP specifications.

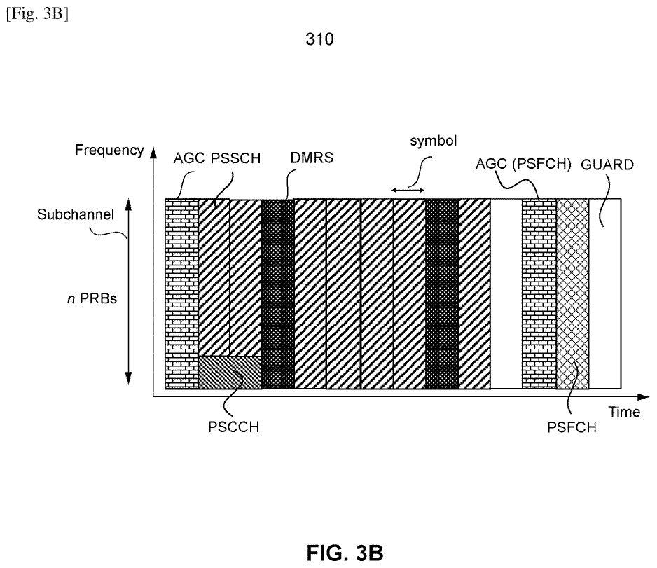

FIG. 4 is a schematic diagram illustrating a method for beam alignment between a UE and a base station, consistent with some embodiments of the present disclosure. The UE and the base station may be connected through Uu interface, as described in the 3GPP specifications. Referring to FIG. 4, a method 400 for beam management between a UE and a base station (e.g., gNB, eNB) includes three phases: a phase 1, a phase 2, and a phase 3. The phase 1 includes a step 402 of performing base station's Tx beam sweeping by transmitting synchronization signal blocks (SSB) from the base station. For example, the base station may generate a synchronization signal (SS) burst to transmit synchronization signals using Tx beamforming. The SS burst may include a plurality of continuous SS blocks (SSBs). The SSBs may be swept and transmitted in different angular directions covering the base station. The UE may use a wide Rx beam to receive the SSBs. The UE measures the quality of the SSBs, for example, reference signal received power (RSRP) for all SSBs on all the UE panels and selects a best SSB beam. The UE then transmits physical random access channel (PRACH) on the RACH occasion associated with the best SSB beam to connect to the base station with the re-ciprocal Tx beam. The reciprocity between the UE's Rx beam associated with the best SSB beam transmitted from the base station and the corresponding UE's Tx beam may hold. In particular, at a step 404, the UE transmits a random access preamble (Message 1 or Msg1) to the base station. Msg1 is a physical layer message. At a step 406, the base station transmits a random access response (RAR) (Message 2 or Msg2) to the UE, as a response to the Msg1. Msg2 is a MAC layer message. At a step 408, the UE transmits an RRC connection request or an RRC connection resume request (Message 3 or Msg3) to the base station. Msg3 is an RRC layer request. At a step 410, the base station transmits an RRC connection setup message or an RRC connection resume message (Message 4 or Msg4) to the UE.

In the phase 2, at a step 412, the base station may perform Tx beam sweeping using refined downlink channel state information-reference signal (CSI-RS) beam within the connected SSB beam. The UE may use a wide Rx beam to receive the base station's refined downlink CSI-RS beam sweeping. The UE measures the quality (e.g., RSRP) for all CSI-RS beams and reports the measurements to the base station. The UE may report an identification (ID) or a beam indication of a best beam to the base station.

In the phase 3, at a step 414, the base station transmits repeated CSI-RS beams with a selected beam based on the UE's report in the phase 2. The UE sweeps refined Rx beam settings to identify a best narrow Rx beam. At the end of the phase 3, alignment between the base station Tx beam and the UE Rx beam is obtained for a maximized directional gain. At a step of 416, the UE may transmit one or more signals or data to the base station.

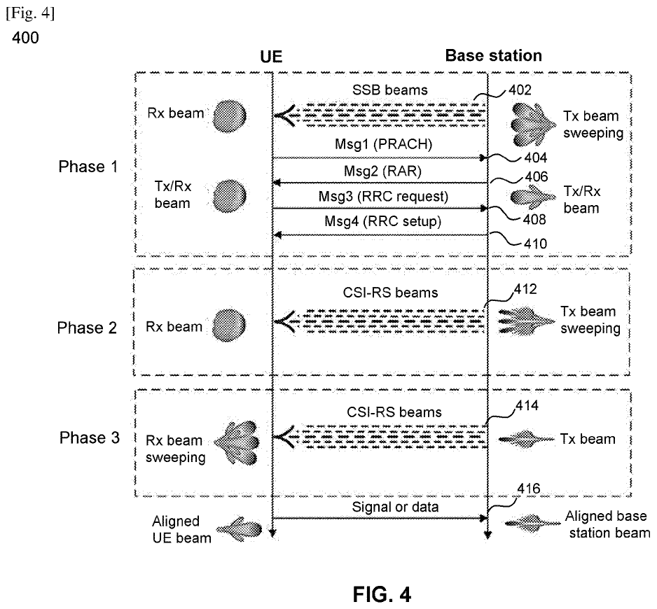

FIG. 5 is a schematic diagram illustrating a method for sidelink beam alignment between two UEs (UE-1 and UE-2) in a sidelink communication, consistent with some embodiments of the present disclosure. The UE-1 may be a primary UE and the UE-2 may be a secondary UE in the sidelink communication. Referring to FIG. 5, a method 500 includes a step 502 of performing a discovery procedure so that the UE-1 and the UE-2 can become aware of each other. In some embodiments, the discovery procedure may be performed based on a proximity-based services (ProSe), as described in the 3GPP specifications. In some embodiments, the discovery procedure may be performed based on Model A or Model B, as defined in the 3GPP specifications. In an embodiment, the UE-1 and the UE-2 are two UEs in a V2X system, and the discovery occurs at the V2X layer. In this embodiment, the discovery may be performed by ex-changing cooperative awareness messages (CAMs) between the two UEs. The exchange of the CAMs between the two UEs may occur in the intelligent transport systems (ITS) band at 5.9 GHZ. In some embodiments, the discovery procedure may be performed in FR1 or FR2. In the present disclosure, FR1 is defined as a frequency range of from 410 to 7125 MHz (including the sub-6 GHz spectrum), and FR2 is defined as two frequency sub-ranges: FR2-1 from 24250 to 52600 MHz and FR2-2 from 52600 to 71000 MHz (including the millimeter wave spectrum).

The method 500 includes a step 504 of establishing a device-to-device connection. The device-to-device connection may be a PC 5 connection, as depicted in the 3GPP specifications. For example, the UE-1 and the UE-2 establish a unicast link via PC5 connection establishment. In some embodiments, the PC5 connection may be performed in FR1 or FR2.

The method 500 includes a step 506 of triggering an initial beam alignment. For example, the UE-1 or the UE-2 may trigger the initial beam alignment. In some embodiments, triggering the initial beam alignment may be performed in FR1 or FR2. In some embodiments, triggering the initial beam alignment may indicate configuration details on the beam alignment. The configuration for the beam alignment may include at least one of: a format for sidelink-beam management reference signal (SL-BMRS) to be used in the beam alignment, a number of expected beam sweeps, or a time period where the beam sweeps are expected.

After the initial beam alignment, the method 500 proceeds with the process of the beam alignment. The beam alignment process includes three phases: a phase 1, a phase 2, and a phase 3. The phase 1 includes a step 508 of performing a wide beam sweeping. For example, the UE-1 may perform a wide beam sweeping using sequential wide Tx beams. In some embodiments, the wide beam sweeping is performed in FR2. In an embodiment, each individual SL-BMRS is transmitted in a single sidelink slot. In this embodiment, for example, if four wide beam sweeps are required, then the UE-1 transmits 4 distinct sidelink slots, each with a different beam applied. However, the resource format for transmitting the SL-BMRS is not so limited. In some embodiments, an individual SL-BMRS is transmitted in any number of slots or symbols, depending on pre-configuration at the UE or a configuration by a network (e.g., a base station). The UE-2 may receive the SL-BMRS using a wide Rx beam.

The phase 1 includes a step 510 of transmitting a sidelink measurement report. For example, the UE-2 performs measurements on the received SL-BMRS and reports an identified best wide SL-BMRS beam to the UE-1. For example, the UE-2 may identify the best wide SL-BMRS beam based on a received power (the highest power) of the SL-BMRS. In some embodiments, the UE-2 may report the index or the slot of the best wide SL-BMRS beam to the UE-1. In some embodiments, the report may be transmitted in FR1 or FR2. The UE-1 may receive the sidelink measurement report using a wide Rx beam. This corresponds to the completion of the phase 1 and the method proceeds with the phase 2.

The phase 2 includes a step 512 of performing a narrow beam sweeping. For example, the UE-1 may perform a narrow Tx SL-BMRS beam sweeping. In some embodiments, the UE-1 may perform the narrow SL-BMRS beam sweeping in FR2. In some embodiments, the narrow Tx beam sweeping utilizes a single slot per beam sweep. The UE-2 may receive the narrow SL-BMRS beam using a wide Rx beam.

The phase 2 includes a step 514 of transmitting a sidelink measurement report. For example, the UE-2 may perform measurements on the received narrow SL-BMRS and report an identified best narrow SL-BMRS beam to the UE-1. In some embodiments, the UE-2 may report the index or the slot of the best narrow SL-BMRS beam to the UE-1. In some embodiments, the sidelink measurement may be transmitted in FR1 or FR2. The UE-1 may receive the sidelink measurement report using a wide Rx beam.

This corresponds to the completion of the phase 2 and the method 500 proceeds with the phase 3.

The phase 3 includes a step 516 of repeating the beam sweeping on a selected narrow Tx beam. For example, the UE-1 may perform m repetitions (m is an integer) of the SL-BMRS sweeping using the selected narrow Tx beam. The UE-2 may perform a narrow Rx beam sweeping to identify a best narrow Rx beam. At the end of phase 3, beam alignment between the UE-1 and the UE-2 is obtained for a maximized directional gain, and the UE-1 (or the UE-2) may transmit signals or data.

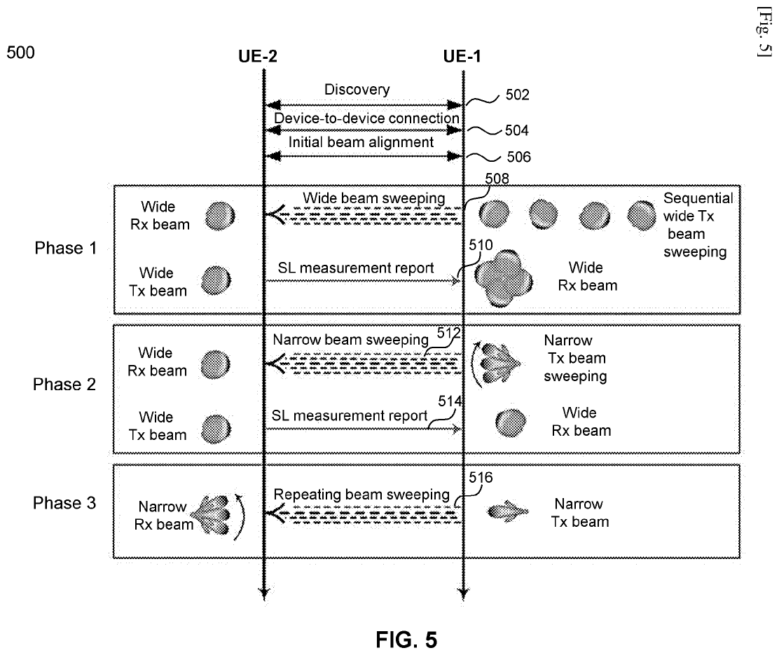

FIG. 6 is a schematic diagram illustrating a method for configuration alignment in a discontinuous reception (DRX), consistent with some embodiments of the present disclosure. Referring to FIG. 6, a method 600 includes a step 602 of transmitting DRX assistance information. For example, an Rx UE may perform a sidelink beam alignment with a Tx UE, using the method 500 of FIG. 5. The Rx UE further transmits DRX assistance information to the Tx UE to inform the Tx UE of a time or time period at which the Rx UE is (or will be) awake or sleeping. Upon reception the DRX assistance information, the Tx UE can determine the timing for the Tx UE to transmit signals or data to the Rx UE. For example, the Tx UE may transmit signals or data to the Rx UE when the Rx UE is awake. The method 600 includes a step 604 of forwarding the DRX assistance information to a base station (e.g., gNB). For example, the Tx UE transmits the DRX assistance information to the base station so that the base station can be aware of the DRX timing. The method 600 includes a step 606 of transmitting a DRX configuration. For example, the base station generates a DRX con-figuration (e.g., a resource configuration for the DRX) and transmits the DRX con-figuration to the Tx UE. The method 600 includes a step 608 of forwarding the DRX configuration to the Rx UE. For example, the Tx UE transmits the received DRX con-figuration to the Rx UE. The method 600 includes a step 610 of providing response to the DRX configuration. For example, upon receipt of the DRX configuration, the Rx UE may send an acceptance message or a rejection message to the Tx UE. When the Rx UE transmits the acceptance message, the Tx UE may transmit signals or data based on the timing in the DRX assistance information and the DRX configuration, and avoid transmitting signals or data when the Rx UE is sleeping. In this way, power consumption in the sidelink communication can be reduced.

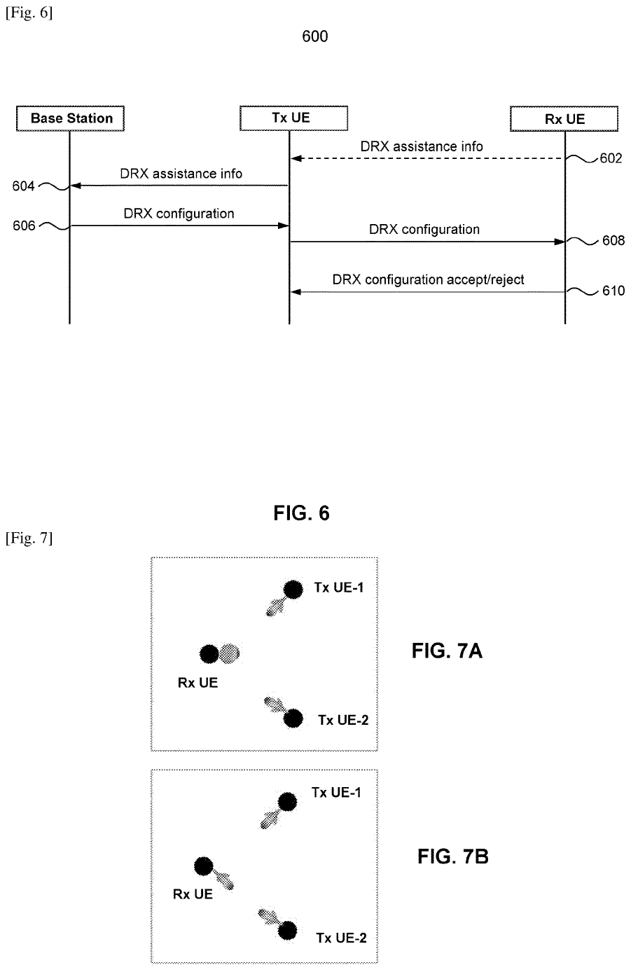

FIG. 7A is a schematic diagram illustrating a sidelink communication between an Rx UE using wide beams and two Tx UEs using narrows beams, FIG. 7B is a schematic diagram illustrating sidelink communication between an Rx UE using narrow beams and two Tx UEs using narrow beams, consistent with some embodiments of the present disclosure. Referring to FIG. 7A, a Tx UE-1 and a Tx UE-2 transmit signals or data to the Rx UE using narrow beams and the Rx UE uses a wide Rx beam to receive the signals or data. The wide Rx beam used in the Rx UE allows reception of transmissions from both the Tx UE-1 and the Tx UE-2 at any time, thereby ensuring stability of the sidelink communication. However, continuously using a wide Rx beam may not practical, especially in high frequency sidelink communications that require beamforming using a narrow beam, to compensate for the high path loss of the high frequency radio signals. Now referring to FIG. 7B, a Tx UE-1 and a Tx UE-2 transmit signals or data to an Rx UE using narrow beams, and the Rx UE uses a narrow Rx beam to receive the transmissions. While the narrow Rx beam may provide advantages for the Rx UE, especially in high frequency bands, the beam correspondence between the narrow Rx beam and the narrow Tx beams may be lost easily. Moreover, the narrow Rx beam may not allow the Rx UE to receive transmissions from the multiple UEs (the Tx UE-1 and the Tx UE-2) at the same time.

At least some embodiments of the present disclosure provide solutions to the problems illustrated in FIG. 7A-7B, by adopting a coordinated beam fallback mechanism as described below. The coordinated beam fallback mechanism allows two sidelink UEs to keep communication even when the two sidelink UEs are about to lose beam correspondence. For example, after a Tx UE and an Rx UE have established sidelink beam alignment using a narrow Tx beam and a narrow Rx beam, the Tx UE and the Rx UE establish a coordination procedure regarding the time at which the Rx UE will apply a wide Rx beam, so that the transition of the beams at Rx UE and/or the Tx UE can be performed before the beam correspondence is completely lost. At least some embodiments of the present disclosure also include a biased resource selection procedure which allows the Tx UE to prioritize selection of a resource where the Rx UE applies a wide Rx beam.

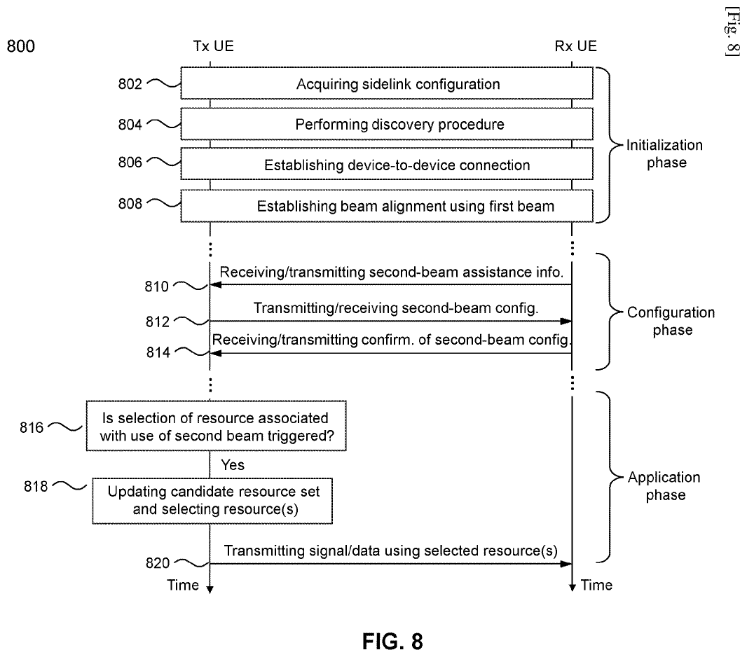

FIG. 8 is a schematic diagram illustrating a method for sidelink beam alignment between two UEs (a Tx UE and an Rx UE) in a sidelink communication, consistent with some embodiments of the present disclosure. Referring to FIG. 8, a method 800 includes three phases: an initialization phase, a configuration phase, and an application phase. The initialization phase includes a step 802 of acquiring sidelink configuration. The sidelink configuration can be acquired in multiple ways. In an embodiment, if there is no base station (e.g., a gNB) around, or if a base station is around but does not transmit a system information block (SIB) 12, then the Tx UE (or the Rx UE) may use a sidelink configuration that is pre-configured at the Tx UE (or the Rx UE). In an embodiment, if the base station transmits SIB12, the Tx UE (or the Rx UE) may obtain the sidelink configuration from the base station. The sidelink configuration may include information about the configuration of the sidelink physical channel and access parameters. The base station is not limited to a gNB, it can be any base station currently existing, such as base stations for LTE or NR, or a base station for a future generation (e.g., 6G, 7G), or any other future generation RAT.

The initialization phase includes a step 804 of performing a discovery procedure between the Tx UE and the Rx UE so that two devices become aware of each other. In some embodiment, the discovery is performed by an application layer of the Tx UE (or the Rx UE) generating announce messages or discovery messages that are broadcasted on the sidelink physical channels. In an embodiment, for example, the application layer of the Rx UE receives a decoded message from the Tx UE and determines whether a unicast connection with the Tx UE should be established. If the application layer of the Rx UE determines that a unicast connection with the Tx UE should be established, the application layer generates a message towards the Tx UE.

The initialization phase includes a step 806 of establishing a device-to-device connection. In an embodiment, the device-to-device connection is a PC5-RRC connection. For example, when the Tx UE and the Rx UE decide to establish a unicast connection, then they can establish a PC5-RRC connection. The Tx UE and the Rx UE may further exchange device capabilities. The device capabilities may include beam forming capabilities.

The initialization phase includes a step 808 of performing beam alignment between the Tx UE and the Rx UE and establishing the beam alignment using a first beam. For example, the Tx UE and the Rx UE may perform the beam alignment using the method 500 as shown in FIG. 5. Upon completion of the three phases of the beam alignment procedure, as shown in FIG. 5, the Tx UE and the Rx UE establish a beam alignment using a first beam. The first beam may be a narrow beam. The narrow beam may be a directional beam. The beam width of the narrow beam can be adjusted by the UE, for example, by adjusting the number of antenna elements or the beamforming gain, etc. The first beam may be a high frequency beam, such as FR2.

After the initialization phase, the method 800 proceeds with a configuration phase. The configuration phase includes a step 810 of receiving (transmitting) a second-beam assistance indication. For example, the Rx UE transmits the second-beam assistance indication to the Tx UE and the Tx UE receives the transmitted second-beam assistance indication. In some embodiments, the second beam may be a wide beam (e.g., at least wider than the first beam). The beam width of the wide beam can be adjusted by the Rx UE (or the Tx UE), for example, by adjusting the number of antenna elements or the beamforming gain, etc. In some embodiments, the second beam is FR1 or FR2. In some embodiments, the Rx UE generates the second-beam assistance indication based on at least one of: one or more channel busy ratio (CBR) ranges, an absolute speed range of the Tx UE, an absolute speed range of the Rx UE, a range of a relative speed between the Tx UE and the Rx UE, or priority information of one or more packets transmitted from the Tx UE. The absolute speed range of the Tx UE, the absolute speed range of the Rx UE, and the range of the relative speed between the Tx UE and the Rx UE may be determined based on an exchange of absolute speeds and headings of the Tx UE and the Rx UE. In some embodiments, the second-beam assistance indication may indicate at least one of time information or frequency information associated with the second beam for the Rx UE for reception of signals or data from the Tx UE. For example, the time information or the frequency information may include a time or a frequency which the Rx UE wants to use for utilizing the second beam as a new Rx beam for reception of the signals or data from the Tx UE. In some embodiments, the second-beam assistance indication includes assistance information for use of the second beam as a second-reception beam at the Rx UE, where the assistance information includes at least one of: a periodicity of the second-reception beam, an offset of the second-reception beam, a duration of the second-reception beam, one or more frequency resources, a reception panel orientation, or a reception beam width.

The configuration phase includes a step 812 of transmitting (or receiving) a second-beam configuration. For example, in response to receiving the second-beam assistance indication, the Tx UE generates a second-beam configuration and transmits the second-beam configuration to the Rx UE and the Rx UE receives the second beam con-figuration. In some embodiments, the Tx UE generates the second-beam configuration based on one or more scheduling constraints of the Tx UE. The one or more scheduling constraints of the Tx UE may include at least one of: a reception-beam-fallback con-figuration with a third UE that causes a reception-beam fallback from the second beam, or a preexisting discontinuous reception configuration that needs to be maintained at the Tx UE. In some embodiments, the second-beam configuration includes second-reception-beam-configuration information for the second-reception-beam to be used by the Rx UE. The second-reception-beam-configuration information may include at least one of: a periodicity of the second reception beam, an offset of the second reception beam, a duration of the second reception beam, one or more frequency resources, a reception panel orientation, a reception beam width, an acceptance of a configuration included in the second-beam assistance indication, or a rejection of the configuration included in the second-beam assistance indication.

The configuration phase includes a step 814 of receiving (or transmitting) a confirmation of the second-beam configuration. For example, after transmitting the second-beam configuration, the Tx UE may receive a confirmation of the second-beam configuration from the Rx UE. In some embodiments, the confirmation of the second-beam configuration is received over a RRC signaling, a MAC CE, or a physical layer signaling. The physical layer signaling may include at least one of: hybrid automatic repeat request (HARQ), SCI, or PSFCH.

After the configuration phase, the method 800 proceeds with an application phase. The application phase includes a step 816 of determining whether a selection of a resource is triggered, in which the selection of the resource is associated with use of the second beam. For example, upon reception of the confirmation of the second-beam configuration from the Rx UE, the Tx UE may determine whether the selection of a resource is triggered. In some embodiments, the trigger of the selection of the resource includes at least one of: (a) a reception of a negative acknowledgement (NACK) message or non-reception of a HARQ feedback, in response to a transmission of a transport block, (b) a reception of a NACK message or non-reception of a HARQ feedback in response to a retransmission of the transport block, (c) a decrease of one or more signal parameters to below a first threshold, the one or more signal parameters including at least one of: signal to interference and noise ratio (SINR), RSRP, or reference signal strength indicator (RSSI), (d) a decrease of one or more signal parameters from a previous state to a current state exceeds a second threshold, the one or more signal parameters including at least one of SINR, RSRP, or RSSI, or (e) a non-reception of a scheduled transmission.

The application phase includes a step 818 of updating a candidate resource set and selecting one or more resources from an updated candidate resource set, if the selection of the resource is triggered. For example, in response to a determination that the selection of the resource is triggered, the Tx UE may update a candidate resource set and select one or more resources from an updated candidate resource set, such that the one or more selected resources are associated with the use of the second beam. The candidate resource set may be any candidate resource set previously determined by the Tx UE. In some embodiments, updating the candidate resource set includes excluding, from the candidate resource set, one or more resources that are not associated with the use of the second beam to form a new candidate resource set. After the updating, the new candidate resource set is associated with the use of the second beam. For example, the new candidate resource set may only include resources associated with the use of the second beam. In some embodiments, the second beam is a wide beam, and the resources not including the wide Rx beam resources are excluded from the previous candidate resource set. In this way, the Tx UE and the Rx UE can switch back and forth between the first beam and the second beam using the fallback mechanism described above.

The application phase includes a step 820 of transmitting (or receiving) one or more signals or messages using the one or more resources selected from the updated candidate resource set. For example, the Tx UE may transmit one or more signals or messages to the Rx UE using the one or more resources selected from the new candidate resource set. In some embodiments, the one or more signals or messages include at least one of: a beam realignment request, a reception beam realignment request, a reception beam resource, or a reception of PSFCH.

By switching the beam back and forth between the first beam (e.g., a narrow beam) and the second beam (e.g., a wide beam), beam gains are achieved compared with a system that only uses a single beam (the first beam or the second beam). In addition, since the Tx UE and the Rx UE have a fallback mechanism, they can achieve faster beam-realignment if communication over the first beam (e.g., a narrow beam) is likely to fail, leading to the improved reliability and efficiency in the sidelink communication.

The methods described in this disclosure can be applied to any sidelink communications, for example, LTE or NR or a future generation (e.g., 6G, 7G, or any future generation) sidelink communications. The methods described in this disclosure can also be applied to a sidelink communication involving any number of UEs. The methods described in this disclosure can also be applied to downlink/uplink communications between a base station and a UE. The methods described in this disclosure can also be applied to other systems, for example, the systems that comply with other standards (e.g., the Institute of Electrical and Electronics Engineers (IEEE) standards), for example, IEEE 802.11 technologies.

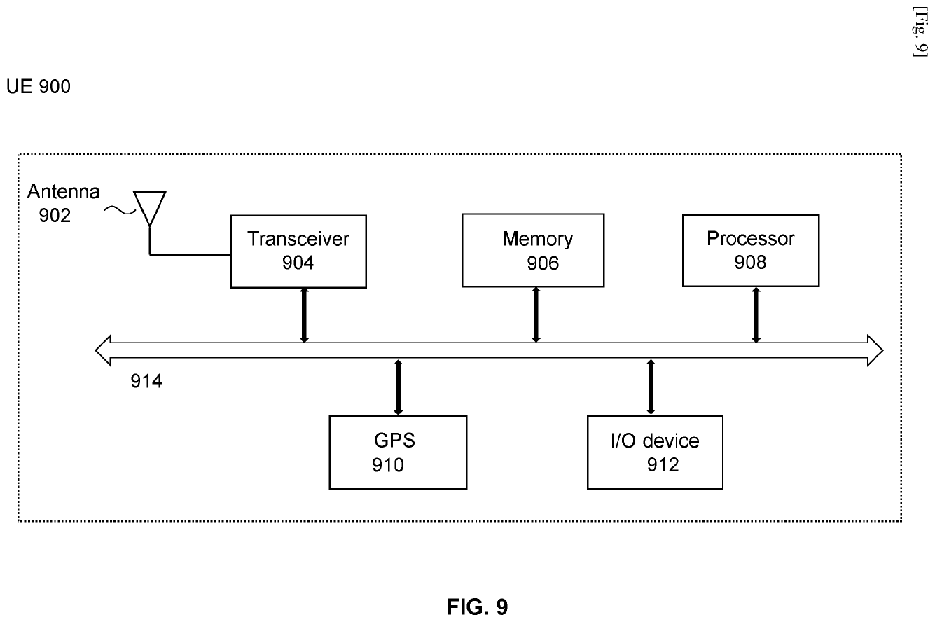

FIG. 9 is a block diagram of a UE 900, consistent with some embodiments of the present disclosure. For example, the UE 900 may be the Tx UE or the Rx UE of FIG. 8 and performs the method of FIG. 8. The UE 900 may be mounted in a moving vehicle or in a fixed position. UE 900 may take any form, including but not limited to, a vehicle, a component mounted in a vehicle, a road-side unit, a laptop computer, a wireless terminal including a mobile phone, a wireless handheld device, or wireless personal device, or any other form.

Referring to FIG. 9, the UE 900 may include antenna 902 that may be used for transmission or reception of electromagnetic signals to/from a base station or other UEs. The antenna 902 may include one or more antenna elements and may enable different input-output antenna configurations, for example, multiple input multiple output (MIMO) configuration, multiple input single output (MISO) configuration, and single input multiple output (SIMO) configuration. In some embodiments, the antenna 902 may include multiple (e.g., tens or hundreds) antenna elements and may enable multi-antenna functions such as beamforming. In some embodiments, the antenna 902 is a single antenna. In some embodiments, the antenna 902 can provide the wide beam and the narrow beam as described in FIG. 5 and FIG. 8, and can switch from between the wide beam and the narrow beam as needed.

The UE 900 may include a transceiver 904 that is coupled to the antenna 902. The transceiver 904 may be a wireless transceiver at the UE 900 and may communicate bi-directionally with a base station or other UEs. For example, the transceiver 904 may receive/transmit wireless signals from/to a base station via downlink/uplink communication. The transceiver 904 may also receive/transmit wireless signals from/to another UE or road side unit via sidelink communication. The transceiver 904 may include a modem to modulate the packets and provide the modulated packets to the antenna 902 for transmission, and to demodulate packets received from the antenna 902.

The UE 900 may include a memory 906. The memory 906 may be any type of computer-readable storage medium including volatile or non-volatile memory devices, or a combination thereof. The computer-readable storage medium includes, but is not limited to, non-transitory computer storage media. A non-transitory storage medium may be accessed by a general purpose or special purpose computer. Examples of non-transitory storage medium include, but are not limited to, a portable computer diskette, a hard disk, random access memory (RAM), read-only memory (ROM), an erasable programmable read-only memory (EPROM), electrically erasable programmable ROM (EEPROM), a digital versatile disk (DVD), flash memory, compact disk (CD) ROM or other optical disk storage, magnetic disk storage or other magnetic storage devices, etc. A non-transitory medium may be used to carry or store desired program code means (e.g., instructions and/or data structures) and may be accessed by a general-purpose or special-purpose computer, or a general-purpose or special-purpose processor. In some examples, the software/program code may be transmitted from a remote source (e.g., a website, a server, etc.) using a coaxial cable, fiber optic cable, twisted pair, digital subscriber line (DSL), or wireless technologies such as infrared, radio, and microwave. In such examples, the coaxial cable, fiber optic cable, twisted pair, DSL, or wireless technologies such as infrared, radio, and microwave are within the scope of the definition of medium. Combinations of the above examples are also within the scope of computer-readable medium.

The memory 906 may store information related to identities of UE 900 and the signals and/or data received by antenna 902. The memory 906 may also store post-processing signals and/or data. The memory 906 may also store computer-readable program instructions, mathematical models, and algorithms that are used in signal processing in receiver 904 and computations in processor 908. The memory 906 may further store computer-readable program instructions for execution by processor 908 to operate UE 900 to perform various functions described in this disclosure. In some examples, the memory 906 may include a basic input/output system (BIOS) which may control basic hardware or software operation such as the interaction with pe-ripheral components or devices.

The computer-readable program instructions of the present disclosure may be assembler instructions, instruction-set-architecture (ISA) instructions, machine instructions, machine-dependent instructions, microcode, firmware instructions, state-setting data, or source code or object code written in any combination of one or more programming languages, including an object-oriented programming language, and con-ventional procedural programming languages. The computer-readable program instructions may execute entirely on a computing device as a stand-alone software package, or partly on a first computing device and partly on a second computing device remote from the first computing device. In the latter scenario, the second, remote computing device may be connected to the first computing device through any type of network, including a local area network (LAN) or a wide area network (WAN).

The UE 900 may include a processor 908 that may include a hardware device with processing capabilities. The processor 908 may include at least one of a general-purpose processor, a digital signal processor (DSP), a central processing unit (CPU), a microcontroller, an application specific integrated circuit (ASIC), a field programmable gate array (FPGA), a programmable logic device, a discrete gate or transistor logic component, a discrete hardware component, or other programmable logic device. Examples of the general-purpose processor include, but are not limited to, a microprocessor, any conventional processor, a controller, a microcontroller, or a state machine. In some embodiments, the processor 908 may be implemented using a combination of devices (e.g., a combination of a DSP and a microprocessor, multiple microprocessors, one or more microprocessors in conjunction with a DSP core, or any other such configuration). The processor 908 may receive, from the transceiver 904, downlink signals or sidelink signals and further process the signals. The processor 908 may also receive, from the transceiver 904, data packets and further process the packets. In some embodiments, the processor 908 may be configured to operate a memory using a memory controller. In some embodiments, a memory controller may be integrated into the processor 908. The processor 908 may be configured to execute computer-readable instructions stored in a memory (e.g., the memory 906) to cause the UE 900 to perform various functions.

The UE 900 may include a global positioning system (GPS) 910. The GPS 910 may be used for enabling location-based services or other services based on a geographical position of the UE 900 and/or synchronization among UEs. The GPS 910 may receive global navigation satellite systems (GNSS) signals from a single satellite or a plurality of satellite signals via the antenna 902 and provide a geographical position of the UE 900 (e.g., coordinates of the UE 900). In some embodiments, the GPS 910 is omitted. In some embodiments, a timer is included.

The UE 900 may include an input/output (I/O) device 912 that may be used to communicate a result of signal processing and computation to a user or another device. The I/O device 912 may include a user interface including a display and an input device to transmit a user command to processor 908. The display may be configured to display a status of signal reception at the UE 900, the data stored at memory 906, a status of signal processing, and a result of computation, etc. The display may include, but is not limited to, a cathode ray tube (CRT), a liquid crystal display (LCD), a light-emitting diode (LED), a gas plasma display, a touch screen, or other image projection devices for displaying information to a user. The input device may be any type of computer hardware equipment used to receive data and control signals from a user. The input device may include, but is not limited to, a keyboard, a mouse, a scanner, a digital camera, a joystick, a trackball, cursor direction keys, a touchscreen monitor, or audio/ video commanders, etc.

The UE 900 may further include a machine interface 914, such as an electrical bus that connects the transceiver 904, the memory 906, the processor 908, the GPS 910, and the I/O device 912.

In some embodiments, the UE 900 may be a first UE (e.g., a Tx UE as shown in FIG. 8) in a sidelink communication. The processor 908 may be configured or programmed to execute the instructions stored in the memory 906 to establish, using a first beam, a beam alignment with a second UE (e.g., an Rx UE as shown in FIG. 8); receive, from the second UE, a second-beam assistance indication, the second-beam assistance indication indicating at least one of time information or frequency information associated with a second beam for the second UE for reception of a signal or data from the first UE; transmit, to the second UE, a second-beam configuration, in response to receiving the second-beam assistance indication; receive, from the second UE, a confirmation of the second-beam configuration; determine whether a selection of a resource is triggered, the selection of the resource being associated with use of the second beam; in response to a determination that the selection of the resource is triggered, update a candidate resource set and select one or more resources from an updated candidate resource set, such that the one or more selected resources are associated with the use of the second beam; and transmit one or more signals or messages using the one or more resources selected from the updated candidate resource set.

In some embodiments, the UE 900 may be a second UE (e.g., the Rx UE as shown in FIG. 8) in a sidelink communication. The processor 908 may be configured or programmed to execute the instructions stored in the memory 906 to establish, using a first beam, a beam alignment with a first UE (e.g., the Tx UE as shown in FIG. 8); transmit, to the first UE, a second-beam assistance indication, the second-beam assistance indication indicating at least one of time information or frequency information associated with a second beam for the second UE for reception of a signal or data from the first UE; receive, from the first UE, a second-beam configuration, in response to the transmitting the second-beam assistance indication; and transmit, to the first UE, a confirmation of the second-beam configuration.

As used in this disclosure, use of the term “or” in a list of items indicates an inclusive list. The list of items may be prefaced by a phrase such as “at least one of” or “one or more of.” For example, a list of at least one of A, B, or C includes A or B or C or AB (i.e., A and B) or AC or BC or ABC (i.e., A and B and C). Also, as used in this disclosure, prefacing a list of conditions with the phrase “based on” shall not be construed as “based only on” the set of conditions and rather shall be construed as “based at least in part on” the set of conditions. For example, an outcome described as “based on condition A” may be based on both a condition A and a condition B without departing from the scope of this disclosure.

In this specification, the terms “comprise,” “include,” or “contain” may be used inter-changeably and have the same meaning and are to be construed as inclusive and open-ended. The terms “comprise,” “include,” or “contain” may be used before a list of elements and indicate that at least all of the listed elements within the list exist but other elements that are not in the list may also be present. For example, if A comprises B and C, both {B, C} and {B, C, D} are within the scope of A.

The present disclosure, in connection with the accompanied drawings, describes example configurations that are not representative of all the examples that may be implemented or all configurations that are within the scope of this disclosure. The term “exemplary” should not be construed as “preferred” or “advantageous compared to other examples” but rather “an illustration, an instance or an example.” By reading this disclosure, including the description of the embodiments and the drawings, it will be appreciated by a person of ordinary skills in the art that the technology disclosed herein may be implemented using alternative embodiments. The person of ordinary skill in the art would appreciate that the embodiments, or certain features of the embodiments described herein, may be combined to arrive at yet other embodiments for practicing the technology described in the present disclosure. Thus, the disclosure is not limited to the examples and designs described herein but is to be accorded the broadest scope consistent with the principles and novel features disclosed herein.

The flowcharts and block diagrams in the figures illustrate examples of the ar-chitecture, functionality, and operation of possible implementations of systems, methods, and devices according to various embodiments. It should be noted that, in some alternative implementations, the functions noted in blocks may occur out of the order noted in the figures. For example, two blocks shown in succession may, in fact, be executed substantially concurrently, or the blocks may sometimes be executed in the reverse order, depending upon the functionality involved. Likewise, additional steps may be included in such methods, and certain steps may be omitted or combined, in methods consistent with various embodiments.

It is understood that the described embodiments are not mutually exclusive, and elements, components, materials, or steps described in connection with one example embodiment may be combined with, or eliminated from, other embodiments in suitable ways to accomplish desired design objectives.

Reference herein to “some embodiments” or “some exemplary embodiments” means that a particular feature, structure, or characteristic described in connection with the embodiment can be included in at least one embodiment. The appearance of the phrases “one embodiment” “some embodiments” or “another embodiment” in various places in the present disclosure do not all necessarily refer to the same embodiment, nor are separate or alternative embodiments necessarily mutually exclusive of other embodiments.

Additionally, the articles “a” and “an” as used in the present disclosure and the appended claims should generally be construed to mean “one or more” unless specified otherwise or clear from context to be directed to a singular form.

Unless explicitly stated otherwise, each numerical value and range should be interpreted as being approximate as if the word “about” or “approximately” preceded the value of the value or range.

Although the elements in the following method claims, if any, are recited in a particular sequence, unless the claim recitations otherwise imply a particular sequence for implementing some or all of those elements, those elements are not necessarily intended to be limited to being implemented in that particular sequence.

It is appreciated that certain features of the present disclosure, which are, for clarity, described in the context of separate embodiments, may also be provided in combination in a single embodiment. Conversely, various features of the specification, which are, for brevity, described in the context of a single embodiment, may also be provided separately or in any suitable subcombination or as suitable in any other described embodiment of the specification. Certain features described in the context of various embodiments are not essential features of those embodiments, unless noted as such.

It will be further understood that various modifications, alternatives, and variations in the details, materials, and arrangements of the parts which have been described and illustrated in order to explain the nature of described embodiments may be made by those skilled in the art without departing from the scope. Accordingly, the following claims embrace all such alternatives, modifications, and variations that fall within the terms of the claims.
1. Clause 1: A first user equipment (UE) for a sidelink communication, the first UE comprising:
a memory storing an instruction; and
a processor configured to execute the instruction stored in the memory to:
establish, using a first beam, a beam alignment with a second UE;
receive, from the second UE, a second-beam assistance indication, the second-beam assistance indication indicating at least one of time information or frequency information associated with a second beam for the second UE for reception of a signal or data from the first UE;
transmit, to the second UE, a second-beam configuration, in response to receiving the second-beam assistance indication;
receive, from the second UE, a confirmation of the second-beam configuration;
determine whether a selection of a resource is triggered, the selection of the resource being associated with use of the second beam;
in response to a determination that the selection of the resource is triggered, update a candidate resource set and select one or more resources from an updated candidate resource set, such that the one or more selected resources are associated with the use of the second beam; and
transmit one or more signals or messages using the one or more resources selected from the updated candidate resource set.
Clause 2: The first UE of clause 1, wherein in updating the candidate resource set, the processor is further configured to execute the instruction to:
exclude, from the candidate resource set, one or more resources that are not associated with the use of the second beam to form a new candidate resource set.
Clause 3: The first UE of clause 2, wherein the new candidate resource set is associated with the use of the second beam.
Clause 4: The first UE of clause 1, wherein the second beam is wider than the first beam.
Clause 5: The first UE of clause 1, wherein the second-beam assistance indication comprises assistance information for the use of the second beam as a second-reception beam, the assistance information including at least one of: a periodicity of the second-reception beam, an offset of the second-reception beam, a duration of the second-reception beam, one or more frequency resources, a reception panel orientation, or a reception beam width.
Clause 6: The first UE of clause 1, wherein the processor is further configured to execute the instruction to:

generate the second-beam configuration based on one or more scheduling constraints of the first UE.
Clause 7: The first UE of clause 6, wherein the one or more scheduling constraints of the first UE comprises at least one of:
a reception-beam-fallback configuration with a third UE that causes a reception-beam fallback from the second beam, or
a preexisting discontinuous reception configuration that needs to be maintained.
Clause 8: The first UE of clause 1, wherein the second-beam configuration comprises second-reception-beam-configuration information, the second-reception-beam-configuration information including at least one of: a periodicity of the second reception beam, an offset of the second reception beam, a duration of the second reception beam, one or more frequency resources, a reception panel orientation, a reception beam width, an acceptance of a configuration included in the second-beam assistance indication, or a rejection of the configuration included in the second-beam assistance indication.
Clause 9: The first UE of clause 1, wherein the confirmation of the second-beam con-figuration is transmitted over a radio resource control (RRC) signaling, a medium access control (MAC) control element (CE) signaling, or a physical layer signaling.
Clause 10: The first UE of clause 9, wherein the physical layer signaling comprises at least one of: hybrid automatic repeat request (HARQ), sidelink control information (SCI), or physical sidelink feedback channel (PSFCH).
Clause 11: The first UE of clause 1, wherein the trigger of the selection of the resource comprises at least one of:
(a) a reception of a negative acknowledgement (NACK) message or non-reception of a HARQ feedback, in response to a transmission of a transport block,
(b) a reception of a NACK message or non-reception of a HARQ feedback in response to a retransmission of the transport block,
(c) a decrease of one or more signal parameters to below a first threshold, the one or more signal parameters including at least one of: signal to interference and noise ratio (SINR), reference signal received power (RSRP), or reference signal strength indicator (RSSI),
(d) a decrease of one or more signal parameters from a previous state to a current state exceeds a second threshold, the one or more signal parameters including at least one of SINR, RSRP, or RSSI, or
(e) a non-reception of a scheduled transmission.
Clause 12: The first UE of clause 1, wherein the one or more signals or messages comprise at least one of: a beam realignment request, a reception beam realignment request, a reception beam resource, or a reception of PSFCH.
Clause 13: The first UE of clause 1, wherein in establishing the beam alignment with the second UE using the first beam, the processor is further configured to execute the instruction to:
acquire a sidelink configuration from a network or a sidelink pre-configuration; discover the second UE using a discovery message; establish a unicast connection with the second UE; and perform a beam alignment procedure to establish the beam alignment with the second UE using the first beam.
Clause 14: The first UE of clause 1, wherein the first UE is a transmitter UE, and the second UE is a receiver UE in the sidelink communication.
Clause 15: The first UE of clause 1, wherein the first beam is FR 2 and the second beam is FR1 or FR2.
Clause 16: A second user equipment (UE) for a sidelink communication, the second UE comprising:
a memory storing an instruction; and
a processor configured to execute the instruction stored in the memory to:
establish, using a first beam, a beam alignment with a first UE;
transmit, to the first UE, a second-beam assistance indication, the second-beam assistance indication indicating at least one of time information or frequency information associated with a second beam for the second UE for reception of a signal or data from the first UE;
receive, from the first UE, a second-beam configuration, in response to the transmitting the second-beam assistance indication; and
transmit, to the first UE, a confirmation of the second-beam configuration.
Clause 17: The second UE of clause 16, wherein the second beam is wider than the first beam.
Clause 18: The second UE of clause 16, wherein the second-beam assistance indication is generated based on at least one of: one or more channel busy ratio (CBR) ranges, an absolute speed range of the first UE, an absolute speed range of the second UE, a range of a relative speed between the first UE and the second UE, or priority information of one or more packets transmitted from the first UE.
Clause 19: The second UE of clause 18, wherein the absolute speed range of the first UE, the absolute speed range of the second UE, and the range of the relative speed between the first UE and the second UE are determined based on an exchange of absolute speeds and headings of the first UE and the second UE.
Clause 20: A method for beam management in a sidelink communication, the method comprising:
establishing, by a first UE in the sidelink communication, a beam alignment with a second UE using a first beam;
receiving, from the second UE, a second-beam assistance indication, the second-beam assistance indication indicating at least one of time information or frequency information associated with a second beam for the second UE for reception of a signal or data from the first UE;
transmitting, to the second UE, a second-beam configuration, in response to receiving the second-beam assistance indication;
receiving, from the second UE, a confirmation of the second-beam configuration; determining, by the first UE, whether a selection of a resource is triggered, the selection of resource being associated with use of the second beam;
in response to a determination that the selection of the resource is triggered, updating a candidate resource set and selecting one or more resources from an updated candidate resource set, such that the one or more selected resources are associated with the use of the second beam; and
transmitting one or more signals or messages using the one or more resources selected from the updated candidate resource set.
Clause 21: The method of clause 20, wherein updating the candidate resource set further comprises:
excluding, from the candidate resource set, one or more resources that are not associated with the use of the second beam to form a new candidate resource set.
Clause 22: The method of clause 21, wherein the new candidate resource set is associated with the use of the second beam.
Clause 23: The method of clause 20, wherein the second beam is wider than the first beam.
Clause 24: The method of clause 20, wherein the second-beam assistance indication comprises assistance information for use of the second beam as a second reception beam, the assistance information including at least one of: a periodicity of the second reception beam, an offset of the second reception beam, a duration of the second reception beam, one or more frequency resources, a reception panel orientation, or a reception beam width.
Clause 25: The method of clause 20, further comprising:

generating the second-beam configuration based on one or more scheduling constraints of the first UE.
Clause 26: The method of clause 25, wherein the one or more scheduling constrains of the first UE comprise at least one of:
a reception beam fallback configuration with a third UE that causes a reception beam fall back from the second beam, or a preexisting discontinuous reception configuration that needs to be maintained.
Clause 27: The method of clause 20, wherein the second-beam configuration comprises second reception beam configuration information, the second reception beam configuration information including at least one of: a periodicity of the second reception beam, an offset of the second reception beam, a duration of the second reception beam, one or more frequency resources, a reception panel orientation, a reception beam width, an acceptance of a configuration included in the second-beam assistance indication, or a rejection of the configuration included in the second-beam assistance indication.
Clause 28: The method of clause 20, wherein the confirmation of the second-beam configuration is transmitted over a radio resource control (RRC) signaling, a medium access control (MAC) control element (CE) signaling, or a physical layer signaling.
Clause 29: The method of clause 28, wherein the physical layer signaling comprises at least one of: hybrid automatic repeat request (HARQ), sidelink control information (SCI), or physical sidelink feedback channel (PSFCH).
Clause 30: The method of clause 20, wherein the trigger of the selection of the resource comprises at least one of:
(a) a reception of a negative acknowledgement (NACK) message or non-reception of a HARQ feedback, in response to a transmission of a transport block,
(b) a reception of a NACK message or non-reception of a HARQ feedback in response to a retransmission of the transport block,
(c) a decrease of one or more signal parameters to below a first threshold, the one or more signal parameters including at least one of: signal to interference and noise ratio (SINR), reference signal received power (RSRP), or reference signal strength indicator (RSSI),
(d) a decrease of one or more signal parameters from a previous state to a current state exceeds a second threshold, the one or more signal parameters including at least one of SINR, RSRP, or RSSI, or
(e) a non-reception of a scheduled transmission.
Clause 31: The method of clause 20, wherein the one or more signals or messages comprise at least one of: a beam realignment request, a reception beam realignment request, a reception beam resource, or a reception of PSFCH.
Clause 32: The method of clause 20, wherein establishing the beam alignment with the second UE using the first beam further comprises:
acquiring a sidelink configuration from a network or a sidelink pre-configuration;
discovering the second UE using a discovery message;
establishing a unicast connection with the second UE; and
performing a beam alignment procedure to establish the beam alignment with the second UE using the first beam.
Clause 33: The method of clause 20, wherein the first UE is a transmitter UE, and the second UE is a receiver UE in the sidelink communication.
Clause 34: The method of clause 20, wherein the first beam is FR 2 and the second beam is FR1 or FR2.
Clause 35: A method for beam management in a sidelink communication, the method comprising:
establishing, by a second user equipment (UE) in the sidelink communication, a beam alignment with a first UE using a first beam;
transmitting, to the first UE, a second-beam assistance indication, the second-beam assistance indication indicating at least one of time information or frequency information associated with a second beam for the second UE for reception of a signal or data from the first UE;
receiving, from the first UE, a second-beam configuration, in response to the transmitting the second-beam assistance indication; and
transmitting, to the first UE, a confirmation of the second-beam configuration.
Clause 36: The method of clause 35, wherein the second-beam assistance indication is generated based on at least one of: one or more channel busy ratio (CBR) ranges, an absolute speed range of the first UE, an absolute speed range of the second UE, a range of a relative speed between the first UE and the second UE, or priority information of one or more packets transmitted from the first UE.
Clause 37: The method of clause 36, wherein the absolute speed range of the first UE, the absolute speed range of the second UE, and the range of the relative speed between the first UE and the second UE are determined based on an exchange of absolute speeds and headings of the first UE and the second UE using the first beam.
Clause 38: A non-transitory computer-readable medium storing instructions that are executable by one or more processors of a first user equipment (UE) for a sidelink communication, to perform a method, the method comprising:
establishing, by the first UE, a beam alignment with a second UE for the sidelink communication using a first beam;
receiving, from the second UE, a second beam assistance indication, the second-beam assistance indication indicating at least one of time information or frequency information associated with a second beam for the second UE for reception of a signal or data from the first UE;
transmitting, to the second UE, a second-beam configuration, in response to receiving the second-beam assistance indication;
receiving, from the second UE, a confirmation of the second-beam configuration; determining, by the first UE, whether a selection of a resource is triggered, the selection of resource being associated with use of the second beam;
in response to a determination that the selection of the resource is triggered, updating a candidate resource set and selecting one or more resources from an updated candidate resource set, such that the one or more selected resources are associated with the use of the second beam; and
transmitting one or more signals or messages using the one or more resources selected from the updated candidate resource set.
Clause 39: A non-transitory computer-readable medium storing instructions that are executable by one or more processors of a second user equipment (UE) for a sidelink communication, to perform a method, the method comprising:
establishing a beam alignment with a first UE for the sidelink communication using a first beam;
transmitting, to the first UE, a second-beam assistance indication, the second-beam assistance indication indicating at least one of time information or frequency information associated with a second beam for the second UE for reception of a signal or data from the first UE;
receiving, from the first UE, a second-beam configuration, in response to the transmitting the second-beam assistance indication; and
transmitting, to the first UE, a confirmation of the second-beam configuration.

1. A first user equipment (UE) for a sidelink communication, the first UE comprising:
a memory storing an instruction; and
a processor configured to execute the instruction stored in the memory to:
establish, using a first beam, a beam alignment with a second UE;
receive, from the second UE, a second-beam assistance indication, the second-beam assistance indication indicating at least one of time information or frequency information associated with a second beam for the second UE for reception of a signal or data from the first UE;
transmit, to the second UE, a second-beam configuration, in response to receiving the second-beam assistance indication;
receive, from the second UE, a confirmation of the second-beam configuration;
determine whether a selection of a resource is triggered, the selection of the resource being associated with use of the second beam;
in response to a determination that the selection of the resource is triggered, update a candidate resource set and select one or more resources from an updated candidate resource set, such that the one or more selected resources are associated with the use of the second beam; and
transmit one or more signals or messages using the one or more resources selected from the updated candidate resource set.

2. The first UE of claim 1, wherein in updating the candidate resource set, the processor is further configured to execute the instruction to:
exclude, from the candidate resource set, one or more resources that are not associated with the use of the second beam to form a new candidate resource set.

3. The first UE of claim 1, wherein the second beam is wider than the first beam.

4. The first UE of claim 1, wherein the second-beam assistance indication comprises assistance information for the use of the second beam as a second-reception beam, the assistance information including at least one of: a periodicity of the second-reception beam, an offset of the second-reception beam, a duration of the second-reception beam, one or more frequency resources, a reception panel orientation, or a reception beam width.

5. The first UE of claim 1, wherein the processor is further configured to execute the instruction to:
generate the second-beam configuration based on one or more scheduling constraints of the first UE.

6. The first UE of claim 1, wherein the one or more scheduling constraints of the first UE comprises at least one of:
a reception-beam-fallback configuration with a third UE that causes a reception-beam fallback from the second beam, or
a preexisting discontinuous reception configuration that needs to be maintained.

7. The first UE of claim 1, wherein the second-beam configuration comprises second-reception-beam-configuration information, the second-reception-beam-configuration information including at least one of: a periodicity of the second reception beam, an offset of the second reception beam, a duration of the second reception beam, one or more frequency resources, a reception panel orientation, a reception beam width, an acceptance of a configuration included in the second-beam assistance indication, or a rejection of the configuration included in the second-beam assistance indication.

8. The first UE of claim 1, wherein the confirmation of the second-beam configuration is transmitted over a radio resource control (RRC) signaling, a medium access control (MAC) control element (CE) signaling, or a physical layer signaling.

9. The first UE of claim 1, wherein the trigger of the selection of the resource comprises at least one of:
(a) a reception of a negative acknowledgement (NACK) message or non-reception of a HARQ feedback, in response to a transmission of a transport block,
(b) a reception of a NACK message or non-reception of a HARQ feedback in response to a retransmission of the transport block,
(c) a decrease of one or more signal parameters to below a first threshold, the one or more signal parameters including at least one of: signal to interference and noise ratio (SINR), reference signal received power (RSRP), or reference signal strength indicator (RSSI),
(d) a decrease of one or more signal parameters from a previous state to a current state exceeds a second threshold, the one or more signal parameters including at least one of SINR, RSRP, or RSSI, or
(e) a non-reception of a scheduled transmission.

10. The first UE of claim 1, wherein the one or more signals or messages comprise at least one of: a beam realignment request, a reception beam realignment request, a reception beam resource, or a reception of PSFCH.

11. The first UE of claim 1, wherein in establishing the beam alignment with the second UE using the first beam, the processor is further configured to execute the instruction to:
acquire a sidelink configuration from a network or a sidelink pre-configuration;
discover the second UE using a discovery message;
establish a unicast connection with the second UE; and
perform a beam alignment procedure to establish the beam alignment with the second UE using the first beam.

12. A second user equipment (UE) for a sidelink communication, the second UE comprising:
a memory storing an instruction; and
a processor configured to execute the instruction stored in the memory to:
establish, using a first beam, a beam alignment with a first UE;
transmit, to the first UE, a second-beam assistance indication, the second-beam assistance indication indicating at least one of time information or frequency information associated with a second beam for the second UE for reception of a signal or data from the first UE;
receive, from the first UE, a second-beam configuration, in response to the transmitting the second-beam assistance indication; and
transmit, to the first UE, a confirmation of the second-beam configuration.

13. The second UE of claim 12, wherein the second beam is wider than the first beam.

14. The second UE of claim 12, wherein the second-beam assistance indication is generated based on at least one of: one or more channel busy ratio (CBR) ranges, an absolute speed range of the first UE, an absolute speed range of the second UE, a range of a relative speed between the first UE and the second UE, or priority information of one or more packets transmitted from the first UE.

15. The second UE of claim 14, wherein the absolute speed range of the first UE, the absolute speed range of the second UE, and the range of the relative speed between the first UE and the second UE are determined based on an exchange of absolute speeds and headings of the first UE and the second UE.

16. A method for beam management in a sidelink communication, the method comprising:
establishing, by a first UE in the sidelink communication, a beam alignment with a second UE using a first beam;
receiving, from the second UE, a second-beam assistance indication, the second-beam assistance indication indicating at least one of time information or frequency information associated with a second beam for the second UE for reception of a signal or data from the first UE;
transmitting, to the second UE, a second-beam configuration, in response to receiving the second-beam assistance indication;
receiving, from the second UE, a confirmation of the second-beam configuration;
determining, by the first UE, whether a selection of a resource is triggered, the selection of resource being associated with use of the second beam;
in response to a determination that the selection of the resource is triggered, updating a candidate resource set and selecting one or more resources from an updated candidate resource set, such that the one or more selected resources are associated with the use of the second beam; and
transmitting one or more signals or messages using the one or more resources selected from the updated candidate resource set.

17. The method of claim 16, wherein updating the candidate resource set further comprises:
excluding, from the candidate resource set, one or more resources that are not associated with the use of the second beam to form a new candidate resource set.

18. A method for beam management in a sidelink communication, the method comprising:
establishing, by a second user equipment (UE) in the sidelink communication, a beam alignment with a first UE using a first beam;
transmitting, to the first UE, a second-beam assistance indication, the second-beam assistance indication indicating at least one of time information or frequency information associated with a second beam for the second UE for reception of a signal or data from the first UE;
receiving, from the first UE, a second-beam configuration, in response to the transmitting the second-beam assistance indication; and
transmitting, to the first UE, a confirmation of the second-beam configuration.

19. A non-transitory computer-readable medium storing instructions that are executable by one or more processors of a first user equipment (UE) for a sidelink communication, to perform a method, the method comprising:
establishing, by the first UE, a beam alignment with a second UE for the sidelink communication using a first beam;
receiving, from the second UE, a second beam assistance indication, the second-beam assistance indication indicating at least one of time information or frequency information associated with a second beam for the second UE for reception of a signal or data from the first UE;
transmitting, to the second UE, a second-beam configuration, in response to receiving the second-beam assistance indication;
receiving, from the second UE, a confirmation of the second-beam configuration;
determining, by the first UE, whether a selection of a resource is triggered, the selection of resource being associated with use of the second beam;
in response to a determination that the selection of the resource is triggered, updating a candidate resource set and selecting one or more resources from an updated candidate resource set, such that the one or more selected resources are associated with the use of the second beam; and
transmitting one or more signals or messages using the one or more resources selected from the updated candidate resource set.

20. A non-transitory computer-readable medium storing instructions that are executable by one or more processors of a second user equipment (UE) for a sidelink communication, to perform a method, the method comprising:
establishing a beam alignment with a first UE for the sidelink communication using a first beam;
transmitting, to the first UE, a second-beam assistance indication, the second-beam assistance indication indicating at least one of time information or frequency information associated with a second beam for the second UE for reception of a signal or data from the first UE;
receiving, from the first UE, a second-beam configuration, in response to the transmitting the second-beam assistance indication; and
transmitting, to the first UE, a confirmation of the second-beam configuration.
